(19) United States
(12) Patent Application Publication
(10) Pub. No.: US 2016/0360145 A1
(43) Pub. Date: Dec. 8, 2016

(54) IMAGE QUALITY ADJUSTMENT METHOD AND SYSTEM

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventors: Lin NIE, Beijing (CN); Qiang LI, Beijing (CN)

(73) Assignees: LE HOLDINGS (BEIJING) CO., LTD., Beijing (CN); LE SHI ZHI XIN ELECTRONIC TECHNOLOGY (TIANJIN) LIM ITED, Beijing (CN)

(21) Appl. No.: 15/108,558

(22) PCT Filed: Dec. 9, 2014
(86) PCT No.: PCT/CN2014/093345

§ 371 Date: Jun. 27, 2016

(30) Foreign Application Priority Data
Dec. 27, 2013 (CN) 201310749384.2

(51) Int. Cl. H04N 5/58; H04N 21/485; G06F 3/01

(52) U.S. Cl. CPC H04N 5/58; G06F 3/016; H04N 21/4854

(57) ABSTRACT

Provided are an image quality adjustment method and system, which are suitable for a video device. The image quality adjustment method comprises: when a video device is started, according to whether the current time falls into a pre-determined time period, executing a corresponding image quality adjustment program; invoking a set value of a corresponding image quality parameter by detecting ambient light; and acquiring a reference value of the corresponding image quality parameter by judging the type of the current video content, and then deciding whether to adjust the image quality parameter by comparing the set value with the reference value, thereby realizing the effect of adaptively adjusting the image quality parameter, thus improving the use convenience of the video device.

### TECHNICAL FIELD

The disclosure relates to the field of video devices, and more particularly, to a method and a system for adjusting image quality.

### BACKGROUND

Watching movies or TV programs by the use of video has become one of modes for the modern people to acquire new knowledge or new information, and also may be one mode for recreation and entertainment. When watching movies or TV programs, users may usually adjust the proper image quality according to the use habit and the video content, to increase the sense of immediacy, visual effect or reduce the burden for eyes. For example, when watching movies, the image quality may be adjusted in the theater mode, to achieve the visual enjoyment of watching movies at the cinema; or the image brightness of the video content is considered to be more intense, to reduce the brightness parameter in the image quality. In the foregoing condition, although the user may actively adjust the image quality in the video mode as required by the user interface of the video device to acquire the corresponding visual effect, such adjustment mode tends to cause some problems.

For example, when using the video device according to different requirements and in different time state, the image quality employed when starting up the video device is usually already the same as the image quality when closing the video device in the prior time. For instance, the movie is watched under the state that the image quality is in the mode of movie in the prior time, and the video device is shut down in such mode. When the video device is started up next time, the movie or the TV program is played in the same image quality. Therefore, if the video mode is adjusted according to the type of the different video contents, the image quality of the video device must be readjusted again to meet the user's requirements. It is extremely inconvenient to use.

In addition, the video device frequently adjusts the image quality of different video contents based on different external environments or different user's habits. For example, the brightness of the image quality is reduced accordingly under the condition of insufficient light to lighten the burden of the user's eyes; or after working in the day, the eyes are tired relatively and the requirements for watching the video content at this time may be merely for entertainment, so that the brightness of the image quality is reduced correspondingly to lighten the burden of the user's eyes. However, these adjustment operations still need to be performed by the active operation of the user, thereby causing the inconvenience in use.

### SUMMARY

The disclosure provides a method and a system for adjusting image quality, which are used for solving the problem of inconvenient use caused by manually adjusting image quality parameters with the usage state and the video contents of a video device back and forth.

The embodiments of the disclosure provide the following technical solutions.

One embodiment of the disclosure provides a method for adjusting image quality, which is applicable to a video device. The method for adjusting image quality includes: acquiring a current time of a displaying video of a video device, determining whether the current time falls within a pre-determined time period, calling a default value of an image quality parameter if the current time does not fall within the pre-determined time period, and performing an image quality adjustment procedure if the current time falls within the pre-determined time period. The image quality adjustment procedure includes: detecting a brightness value of ambient light; calling a setting value of a corresponding image quality parameter according to the brightness value; determining the type of the current video content, and acquiring a reference value of the corresponding image quality parameter according to the type of the video content; and comparing the setting value of the image quality parameter with the reference value of the image quality parameter, adjusting and reducing the setting value of the image quality parameter to the reference value of the image quality parameter if the setting value of the image quality parameter is greater than the reference value of the image quality parameter, and continuously calling the setting value of the image quality parameter if the setting value of the image quality parameter is equal to or less than the reference value of the image quality parameter.

One embodiment of the disclosure provides a system for adjusting image quality, which is applicable to a video device. The system for adjusting image quality includes an optical sensor, a timer and a processor. The optical sensor is configured to detect a brightness value of ambient light. The timer is configured to detect the current time of the video device during operation, and be set with a pre-determined time period. The processor is electrically connected to the optical sensor and the timer, the processor judges whether to perform an image quality adjustment procedure according to the current time and the pre-determined time period, and the setting value of a corresponding image quality parameter is called according to the brightness value in the image quality adjustment procedure; and a reference value of the corresponding image quality parameter is acquired according to the video content played by the video device to decide whether to adjust the setting value of the image quality parameter.

Compared with the prior art, the disclosure may acquire the following technical effects.

First, for the method and the system for adjusting image quality of the disclosure, whether to perform the image quality adjustment procedure is performed by the result of determining whether the current time falls within the pre-determined time period by the processor, which increases the flexibility of the application, so that whether to perform the image equality adjustment procedure, and what time point to start performing may be selected according to the use requirements.

Further, according to the method and system for adjusting image quality of the disclosure, during the operation of adjusting the image quality, the setting value of the corresponding image quality parameter is called according to the brightness value and the reference value of the corresponding image quality parameter is acquired according to the type of the video content, then the setting value is compared with the reference value by the processor, and the image quality parameter is also adjusted according to the comparison result, so that the watching environment of the video content with high quality is provided, the manual operation is reduced, and the convenience and practicability in use are greatly improved.

### BRIEF DESCRIPTION OF THE DRAWINGS

FIG. 1 is a block diagram of a system for adjusting image quality, according to an embodiment of the disclosure.

FIG. 2 is a block diagram of a system for adjusting image quality, according to another embodiment of the disclosure.

FIG. 3 is a flow chart of a method for adjusting image quality, according to a first method embodiment of the disclosure.

FIG. 4 is a flow chart of an image quality adjustment procedure, according to the first method embodiment of the disclosure.

FIG. 5 is a flow chart of method for adjusting image quality, according to a second method embodiment of the disclosure.

FIG. 6 is a flow chart of method for adjusting image quality, according to a third method embodiment of the disclosure.

FIG. 7 is a block diagram of a device for adjusting image quality, according to another embodiment of the disclosure.

### DETAILED DESCRIPTION

The implementation manners of the disclosure will be explained in details with reference to the drawings and embodiments hereinafter, so that the realization process of how to solve the technical problems by using a technical means and achieve the technical efficacy can be sufficiently understood and implemented accordingly.

For instance, some vocabularies are used in the description and the claim to refer to specific components. Those skilled in the art should understand hardware manufacturers may employ different nouns to name the same component. According to the description and the claim, the difference in the name is not deemed as a way to distinguish the components, but the difference in the function is deemed as the norm to distinguish the components. For example, “include” as mentioned throughout the description and the claim is an open type term, so it should be explained as “include, but not limited to”. “Approximately” refers to that the technical problems may be solved by those skilled in the part within the certain error scope to basically achieve the technical effects within the receivable error scope. In addition, one term “coupling” or “electrically connecting” includes any direct or indirect electrically coupling means herein. Therefore, if a first device being coupled to a second device is described herein, it represents that the first device may be directly electrically coupled to the second device, or indirectly electrically coupled to the second device through other devices or a coupling means. A preferred implementing manner of the disclosure is described in the description hereinafter, but the description is to describe the general principle of the disclosure, but not intended to limit the scope of the disclosure. The protection scope of the disclosure should be subjected to those defined by the claims.

It should be further noted that, the terms “include”, “comprise” or any variation thereof herein refer to “include but not limited to”. Therefore, in the context of a process, method, commodity or system that includes a series of elements, the process, method, commodity or system not only includes such elements, but also includes other elements not specified expressly, or may include inherent elements of the process, method, commodity or device. Unless otherwise specified, in the context of “include a . . . ”, the process, method, commodity of system that includes or comprises the specified elements may also include other identical elements.

Application Scenarios of the Disclosure

The application context of the disclosure is applicable to the solution of the disclosure when the video device starts up or when the requirement for adjusting the image quality parameter is generated as the brightness value of ambient light is different from the playing type of the video content if the video device has run for a period of time and the video content is being watched.

### Application Scenarios of the Disclosure

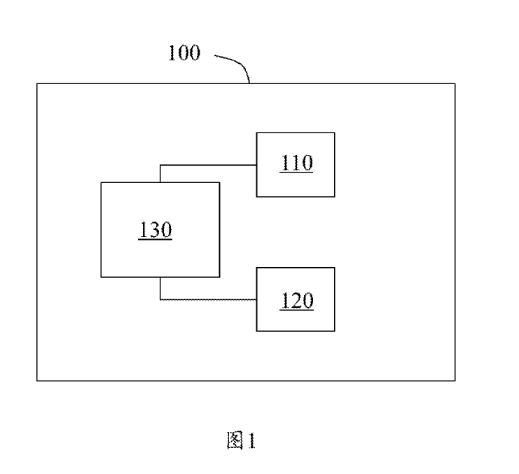

A system for adjusting image quality disclosed by the disclosure is applicable to TVs, displays of computing machines or other video devices for playing video content. FIG. 1 shows a block diagram of a system for adjusting image quality, according to an embodiment of the disclosure. The system for adjusting image quality 100 disclosed by the first embodiment of the disclosure includes an optical sensor 110, a timer 120 and a processor 130. The optical sensor 100 is configured to detect a brightness value of ambient light. The timer 120 is configured to detect the current time of the video device in operation, and set with a pre-determined time period. The processor 130 is electrically connected to the optical sensor 110 and the timer 120, the processor determines whether to perform an image quality adjustment procedure according to the current time during the operation of the video device and the pre-determined time period set by the timer, and the setting value of a corresponding image quality parameter is called according to the brightness value in the image quality adjustment procedure; and a reference value of the corresponding image quality parameter is acquired according to the video content played by the video device to decide whether to adjust the setting value of the image quality parameter.

In addition, in other embodiments of the disclosure, the system for adjusting image quality 100 further includes a database 140, which is electrically connected to the processor 130. The database 140 is stored with the default value of the pre-determined time period, the setting value of the image quality parameter corresponding to the brightness values of different ambient lights and the reference value of the image quality parameter corresponding to the different types of video contents. In the disclosure, the above-mentioned pre-determined time period, the setting value of the image quality parameter and the reference value of the image quality parameter can be preset in the database 140, so as to provide the processor 130 with a reference to determine or call the image quality parameter.

In addition, in some embodiments, the system for adjusting image quality 100 disclosed by the disclosure may further include but not limited to other components, such as a display unit, used for displaying the TV program content; an audio output unit, including a loudspeaker or a speaker (speaker), used for playing the voice of the TV; or a selecting unit, used for operating a user interface (user interface, UI) of the TV 100.

The method for adjusting image quality implemented by the system for adjusting image quality of the disclosure is further described in details with reference to some embodiments of the method hereinafter.

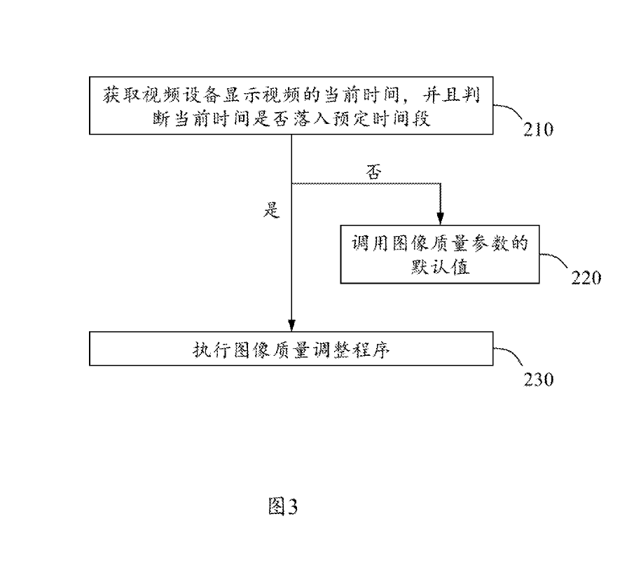

FIG. 3 shows a flow chart of a method for adjusting image quality, according to a first method embodiment of the disclosure. The system for adjusting image quality disclosed by the first method embodiment of the disclosure includes the following steps.

In step 210, a current time of a displaying video of a video device is acquired, and whether the current time falls within a pre-determined time period is determined.

In step 220, a default value of an image quality parameter is called if the current time does not fall within the pre-determined time period.

In step 230, an image quality adjustment procedure is performed if the current time falls within the pre-determined time period.

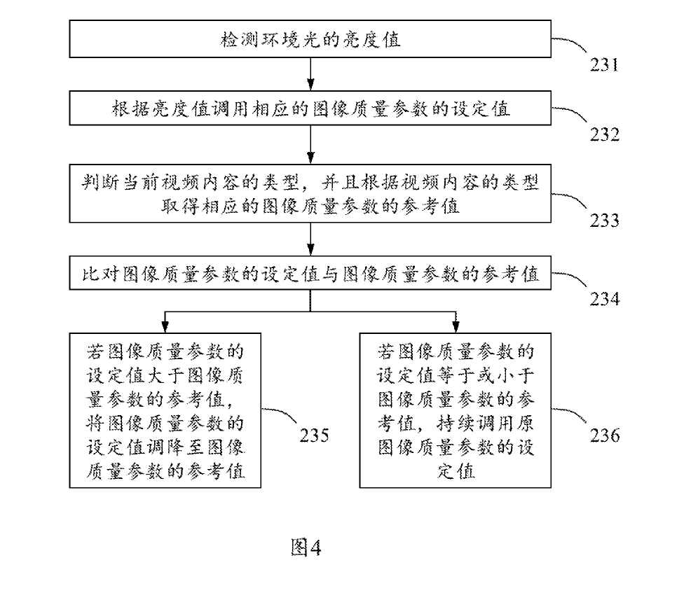

As shown in FIG. 4, the image quality adjustment procedure includes the following steps.

In step 231, a brightness value of ambient light is detected.

In step 232, a setting value of a corresponding image quality parameter is called according to the brightness value.

In step 233, the type of the current video content is determined, and a reference value of the corresponding image quality parameter is acquired according to the type of the video content.

In step 234, the setting value of the image quality parameter is compared with the reference value of the image quality parameter.

In step 235, the setting value of the image quality parameter is adjusted and reduced to the reference value of the image quality parameter if the setting value of the image quality parameter is greater than the reference value of the image quality parameter.

In step 236, the setting value of the original image quality parameter is continuously called if the setting value of the image quality parameter is equal to or less than the reference value of the image quality parameter.

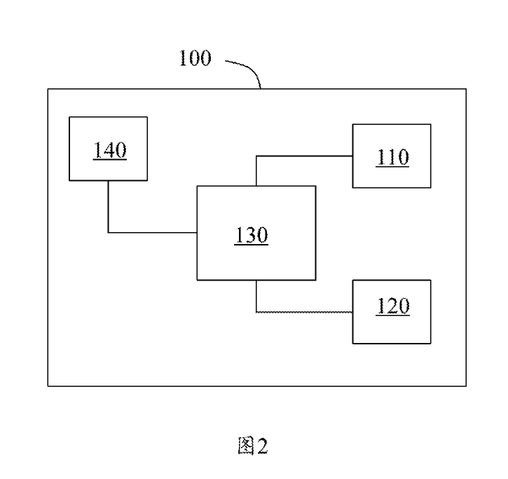

Referring to FIG. 1 to FIG. 4, in the method embodiment, when the video device displays the video, for example when the video device is started up or after playing the video content for a period of time, the current time is detected by the timer 120 of the system for adjusting image quality 100, for example, the starting-up time of the video device, and the current time acquired is transmitted to the processor 130, then the current time is compared in the pre-determined time period by the processor 130, so as to judge whether the current time falls within the pre-determined time period (step 210). Wherein, the pre-determined time period can be set as 24 hours, or be a certain special time interval therein, or several time intervals therein, such as from 6:00 pm to the next 6:00 am, or from 6:00 pm to 12:00 pm and from 5:00 am to 7:00 am, or the like. In the embodiment, the pre-determined time period from 6:00 pm to the next 6:00 am is taken for example to illustrate, but not limited to this.

Therefore, when the starting-up time of the video device is at 10:00 am, the processor 130 determines the current time does not fall within the scope of the pre-determined time, which does not comply with the starting-up condition of the image quality adjustment procedure. The processor 130 calls the default value of the image quality parameter set in the video device as the value of the image quality parameter of playing the current video content to present the picture (step 220). On the contrary, if the starting-up time is at 8:00 pm, the processor 130 determines the current time falls within the pre-determined time, while the image quality adjustment procedure is performed accordingly (step 230).

In the image quality adjustment procedure, first, the brightness value of the ambient light is detected by the optical sensor 110 (step 231), then, the brightness value is received by the processor 130, and the setting value of the corresponding image quality parameter is called according to the brightness value (step 232), wherein the image quality parameter includes but not limited to a brightness parameter, a contrast parameter, a color saturation parameter, a color temperature parameter or the combination of the foregoing parameters, or the like. In order to conveniently describe, the image quality parameter as the brightness parameter in the embodiment is taken for example to illustrate, but not limited to this.

In the operation of calling the setting value of the corresponding image quality parameter according to the brightness value by the processor, it is assumed that the brightness parameter is 55% as the setting value. Then, the type of the current video content is judged by the processor 130, and the reference value of the corresponding image quality parameter is acquired according to the type of the video content (step 233). The type of the video content may be generally divided into movie, general program, TV play and others, and these types of video contents are all pre-set with the reference value of the corresponding image quality parameter, for example, when the video content is the movie, the brightness parameter is 40% as the reference value; when the video content is the general program, the brightness parameter is 50% as the reference value; and when the video content is the TV play, the brightness parameter is 46% as the reference value. Moreover, these reference values may be the maximum value of the image quality parameter capable of being adjusted when playing these video contents, so that the adjustment threshold is preset, so as to avoid reducing the quality of the video due to the oversized image quality parameter.

After the reference value of the corresponding image parameter is called by the processor 130 according to the type of the video content, the processor 130 then compares the setting value with the reference value (step 234), and determines whether to further adjust the image quality parameter according to the comparison result. If the comparison result is that the setting value is greater than the reference value, the processor 130 adjusts and reduces the setting value to the reference value, so that the video content may play the image quality parameter under the current operation environment, and may provide a comfortable visual perception at the same time (step 235). On the contrary, the comparison result is that the setting value is equal to or less than the reference value, which shows that the setting value of the image quality parameter adopted currently has achieved the use requirement of the play environment currently, so that the processor 130 does not act, and thus does not adjust the image quality parameter any more (step 236).

In other words, if the type of the video content played currently is the movie or the general program, the processor 130 adjusts the setting value of the original brightness parameter as 55% to 40% or 50% respectively. On the contrary, if the type of the video content played currently is the TV play, the processor 130 maintains the setting value of the original brightness parameter as 55%.

Based on the above description, the system for adjusting image quality and the method thereof of the disclosure, the image quality parameter is actively adjusted by the processor 130 to be applicable to playing the video content under the current environment according to the current time, the brightness value of the ambient light and the type of the current video content, so as to achieve the optimized parameter setting. In this way, the convenience and practicability in use are improved. In addition, it is worthy of illustrating that the image quality parameter described in the disclosure is not limited by the above-mentioned exemplary parameter type.

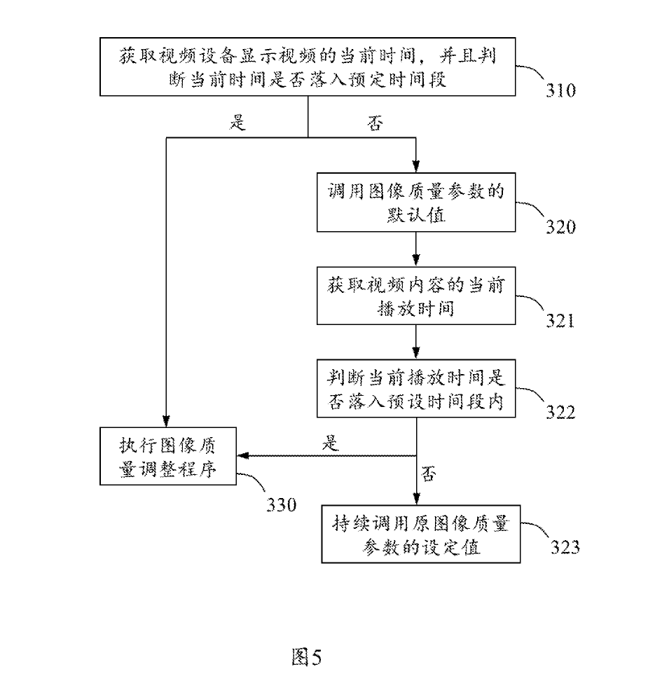

FIG. 5 shows a flow chart of method for adjusting image quality, according to a second method embodiment of the disclosure. In the second method embodiment of the disclosure, step 310, step 320 and step 330 thereof are respectively similar to step 210, step 220 and step 230 in the first method embodiment, which is not elaborated herein. The difference between the two is that the method for adjusting image quality disclosed by the second method embodiment of the disclosure, in the operation of determining whether the current time falls within the pre-determined time period, and after the operation of calling the default value of the image quality parameter when determining the current time does not fall within the pre-determined time period, further includes the following steps.

In step 321, the current playing time of the video content is acquired.

In step 322, whether the current playing time falls within the pre-determined time period is determined, the image quality adjustment procedure is performed if the current playing time falls within the pre-determined time period.

In step 323, the setting value of the original image quality parameter is continuously called if the current playing time does not fall within the pre-determined time period.

Referring to FIG. 1 and FIG. 5, in the method embodiment, the current playing time of the video content is acquired by the timer 120. Then, whether the current playing time falls within the pre-determined time period is determined by the processor 130. If the current playing time falls within the pre-determined time period, the processor 130 performs the image quality adjustment procedure; and if the current playing time does not fall within the pre-determined time period, the processor 130 does not act, so that the video content is continuously played with the setting value of the original image quality parameter. An object of the embodiment is to enable the video device to be also applicable to the method for adjusting image quality of the disclosure after playing the video content for a period of time, so that the convenience and flexibility in use is improved. For example, at the beginning, the current time of the video device when starting up does not fall within the pre-determined time period, so that the processor 130 calls in the default value of the image quality parameter to play the video content. However, after the video content is played for a period of time, the current playing time is detected by the timer 120 in a real-time manner (step 321), and the detection result is transmitted back to the processor 130. The processor 130 determines whether the current playing time falls within the pre-determined time period. The processor 130 performs the operation of the image quality adjustment procedure (step 322) if the current playing time falls within the pre-determined time period, so that the image quality can still be actively adjusted by the processor 130 when the video device plays the video to provide the image quality parameter value applicable to the current video content and the play time. In this way, the image quality of the video content is improved, and the comfortable video picture is provided. On the contrary, if the current playing time still does not fall within the pre-determined time period, the processor 130 does not act, but continuously takes the original setting value as the reference value of the image quality (step 323).

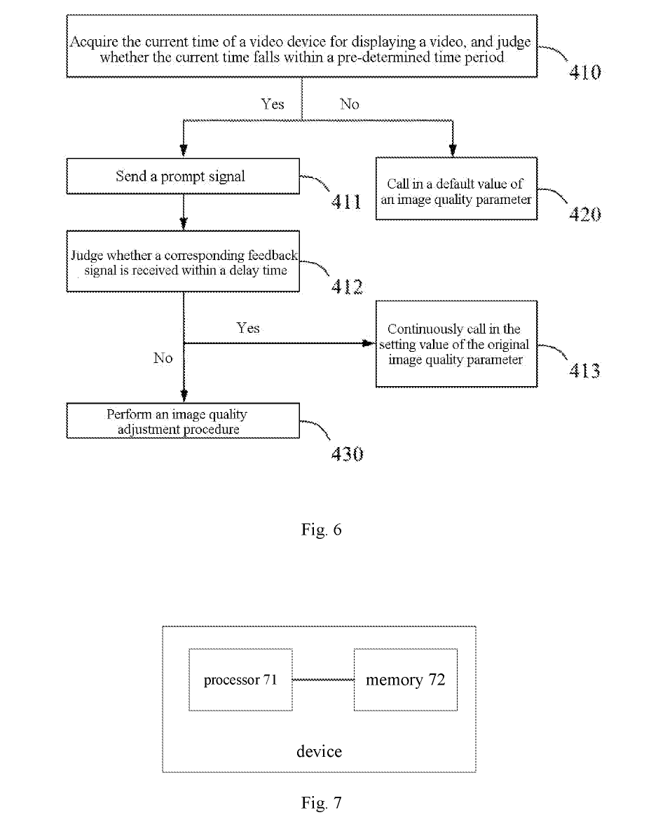

A flow chart of method for adjusting image quality according to a second method embodiment of the disclosure is as shown in FIG. 6. In the third method embodiment of the disclosure, step 410, step 420 and step 430 thereof are respectively similar to step 310, step 320 and step 330 in the first method embodiment, which is not elaborated herein.

Referring to FIG. 1 and FIG. 6, the method for adjusting image quality disclosed by the third method embodiment of the disclosure, before the operation of performing the image quality adjustment procedure, further includes the following steps.

In step 411, a prompt signal is sent.

In step 412, whether a corresponding feedback signal is received within a delay time is determined, the image quality adjustment procedure is performed if the corresponding feedback signal is received within the delay time.

In step 413, the setting value of the original image quality parameter is continuously called if the corresponding feedback signal is not received within the delay time.

In the third method embodiment of the disclosure, a prompt signal is sent by the processor 130 (step 411), and a feedback signal is waited within the delay time. If the feedback signal is not received by the processor within the delay time, the image quality program is performed by the processor 130; otherwise, if the feedback signal is received within the delay time, the processor 130 does not act, and the original setting value is continuously served as the parameter value of the image quality. An object of the embodiment is to play a role in warning when the image quality is going to be adjusted to enable the user to select whether to perform the image quality adjustment procedure. For example, the prompt signal is received by a display unit, and the lamp flickering is controlled or the prompt frame is displayed according to the prompt signal. At this moment, when watching TV, the user will pay attention to a prompt that the image quality is going to be adjusted. Or, the prompt signal is received by a remote controller, and vibration is generated according to the prompt signal, which may also achieve the object of reminding the user of being going to adjust the image quality. Then, after receiving the prompt, if undesired to change the current image equality parameter, the user may send a feedback signal through the remote controller or the selection unit of TV within the delay time, for example, after receiving the prompt that the image quality is going to be adjusted, the feedback signal is sent by the remote controller within 10 s, the processing unit 120 receives the feedback signal and then stops the image quality adjustment procedure according to the feedback signal (Step 413). On the contrary, if agreeing to change the current image quality, the user may set the prompt signal aside and continue to watch TV. Moreover, after exceeding the delay time, the processing unit 120 automatically performs the image quality adjustment procedure by determining that no corresponding feedback signal is received within the delay time (step 412). It is worthy of illustrating that the prompt method used in the embodiment may also be applicable to other embodiments in a similar or the same manner.

FIG. 7 is a block diagram of a device for adjusting image quality, according to another embodiment of the disclosure.

With reference to FIG. 7, a device for adjusting image quality according to the embodiment of the present invention mainly includes: a processor 71; and a memory 72 adapted to store instructions executable by the processor 71; wherein the processor 71 is configured to:

acquiring a current time of a displaying video of the video device, determining whether the current time falls within a pre-determined time period, calling a default value of an image quality parameter if the current time does not fall within the pre-determined time period, and performing an image quality adjustment procedure if the current time falls within the pre-determined time period; wherein the image quality adjustment procedure comprises: detecting a brightness value of ambient light; calling a setting value of a corresponding image quality parameter according to the brightness value; determining the type of the current video content, and acquiring a reference value of the corresponding image quality parameter according to the type of the video content; and comparing the setting value of the image quality parameter with the reference value of the image quality parameter, adjusting and reducing the setting value of the image quality parameter to the reference value of the image quality parameter if the setting value of the image quality parameter is greater than the reference value of the image quality parameter, and continuously calling the setting value of the image quality parameter if the setting value of the image quality parameter is equal to or less than the reference value of the image quality parameter.

In one embodiment. the processor 71 is further configured to: acquiring the current playing time of the video content; and determining whether the current playing time falls within the pre-determined time period; performing the image quality adjustment procedure if the current playing time falls within the pre-determined time period; and continuously calling the setting value of the image quality parameter if the current playing time does not fall within the pre-determined time period.

In one embodiment, the processor 71 is further configured to: sending a prompt signal; and determining whether a corresponding feedback signal is received within a delay time; executing the image quality adjustment procedure if the corresponding feedback signal is received within the delay time; and continuously calling the setting value of the image quality parameter if the corresponding feedback signal is not received within the delay time.

In one embodiment, the processor 71 is further configured to: receiving the prompt signal through a display unit; and controlling lamp flicking according to the prompt signal or displaying a prompt frame.

In one embodiment, the processor 71 is further configured to: receiving the prompt signal through a remote controller; and generating vibrations by the remote controller according to the prompt signal.

In one embodiment, the processor 71 is further configured to: setting the pre-determined time period; setting the setting value of the image quality parameter corresponding to the brightness value; and setting the reference value of the image quality parameter corresponding to the type of the video content.

Moreover, in the method and the system for adjusting image quality disclosed in the embodiments of the disclosure, the pre-determined time period, the setting value of the image quality parameter and the reference value of the image quality parameter may be pre-stored in the database as set forth above; or, in some embodiments of the disclosure, the steps of setting the pre-determined time period, setting the setting value of the image quality parameter corresponding to the brightness value of ambient light, and setting the reference value of the image quality parameter corresponding to the type of the video content may be firstly finished before the operation of determining whether the current time falls within the pre-determined time period. The setting sequence of these parameter values and the time period may be elastically adjusted in the method for adjusting image quality of the disclosure according to the actual requirement.

Various embodiments of the disclosure are shown and described in the description above. But as previously mentioned, it should be understood the disclosure is not limited to the form disclosed in the context, shall not be considered to exclude the other embodiments, but may be used for various other combinations, modifications and environments, and may be changed through the instructions above or the technology or knowledge in the related field within the scope of the invention conception of the text. The modifications and changes made by those skilled in the art without departing from the spirit and scope of the disclosure shall all fall within the protection scope of the claims attached to the disclosure.

1. A method for adjusting image quality, applicable to a video device, comprising:
acquiring a current time of a displaying video of the video device, determining whether the current time falls within a pre-determined time period, calling a default value of an image quality parameter if the current time does not fall within the pre-determined time period, and performing an image quality adjustment procedure if the current time falls within the pre-determined time period;
wherein the image quality adjustment procedure comprises:
detecting a brightness value of ambient light;
calling a setting value of a corresponding image quality parameter according to the brightness value;
determining the type of the current video content, and acquiring a reference value of the corresponding image quality parameter according to the type of the video content; and
comparing the setting value of the image quality parameter with the reference value of the image quality parameter, adjusting and reducing the setting value of the image quality parameter to the reference value of the image quality parameter if the setting value of the image quality parameter is greater than the reference value of the image quality parameter, and continuously calling the setting value of the image quality parameter if the setting value of the image quality parameter is equal to or less than the reference value of the image quality parameter.

2. The method for adjusting image quality according to claim 1, wherein in the step of determining whether the current time falls within the pre-determined time period, after the step of calling the default value of the image quality parameter, further comprises:
acquiring the current playing time of the video content; and
determining whether the current playing time falls within the pre-determined time period; performing the image quality adjustment procedure if the current playing time falls within the pre-determined time period; and continuously calling the setting value of the image quality parameter if the current playing time does not fall within the pre-determined time period.

3. The method for adjusting image quality according to claim 1, wherein before the step of performing the image quality adjustment procedure, further comprises:
sending a prompt signal; and
determining whether a corresponding feedback signal is received within a delay time; executing the image quality adjustment procedure if the corresponding feedback signal is received within the delay time; and continuously calling the setting value of the image quality parameter if the corresponding feedback signal is not received within the delay time.

4. The method for adjusting image quality according to claim 3, wherein between the step of sending the prompt signal and the step of waiting for the corresponding feedback signal within the delay time, further comprises:
receiving the prompt signal through a display unit; and
controlling lamp flicking according to the prompt signal or displaying a prompt frame.

5. The method for adjusting image quality according to claim 3, wherein between the step of sending the prompt signal and the step of waiting for the corresponding feedback signal within the delay time, further comprises:
receiving the prompt signal through a remote controller; and
generating vibrations by the remote controller according to the prompt signal.

6. The method for adjusting image quality according to claim 1, wherein before the operation of determining whether the current time falls within the pre-determined time period, further comprises:
setting the pre-determined time period;
setting the setting value of the image quality parameter corresponding to the brightness value; and
setting the reference value of the image quality parameter corresponding to the type of the video content.

7. A system for adjusting image quality, applicable to a video device, comprising:
an optical sensor being configured to detect a brightness value of ambient light;
a timer being configured to detect the current time of the video device during operation, and be set with a pre-determined time period; and
a processor electrically connected to the optical sensor and the timer, wherein the processor determines whether to perform an image quality adjustment procedure according to the current time and the pre-determined time period, and calls in the setting value of a corresponding image quality parameter according to the brightness value in the image quality adjustment procedure;
and acquires a reference value of the corresponding image quality parameter according to the video content played by the video device to decide whether to adjust the setting value of the image quality parameter.

8. The system for adjusting image quality according to claim 7, further comprising a database electrically connected to the processor, wherein the database is stored with the pre-determined time period, the setting value of the image quality parameter and the reference value of the image quality parameter.

9. The system for adjusting image quality according to claim 7, wherein the image quality parameter comprises a brightness parameter, a contrast parameter, a color saturation parameter or a color temperature parameter.

10. The method for adjusting image quality according to claim 2, wherein before the step of performing the image quality adjustment procedure, further comprises:
sending a prompt signal; and
determining whether a corresponding feedback signal is received within a delay time; executing the image quality adjustment procedure if the corresponding feedback signal is received within the delay time; and continuously calling the setting value of the image quality parameter if the corresponding feedback signal is not received within the delay time.

11. The method for adjusting image quality according to claim 10, wherein between the step of sending the prompt signal and the step of waiting for the corresponding feedback signal within the delay time, further comprises:
receiving the prompt signal through a display unit; and
controlling lamp flicking according to the prompt signal or displaying a prompt frame.

12. The method for adjusting image quality according to claim 10, wherein between the step of sending the prompt signal and the step of waiting for the corresponding feedback signal within the delay time, further comprises:
receiving the prompt signal through a remote controller; and
generating vibrations by the remote controller according to the prompt signal.

13. A device for adjusting image quality, comprising:
a processor; and
a memory adapted to store instructions executable by the processor;
wherein the processor is configured to:
acquiring a current time of a displaying video of the video device, determining whether the current time falls within a pre-determined time period, calling a default value of an image quality parameter if the current time does not fall within the pre-determined time period, and performing an image quality adjustment procedure if the current time falls within the pre-determined time period;
wherein the image quality adjustment procedure comprises: detecting a brightness value of ambient light; calling a setting value of a corresponding image quality parameter according to the brightness value; determining the type of the current video content, and acquiring a reference value of the corresponding image quality parameter according to the type of the video content; and comparing the setting value of the image quality parameter with the reference value of the image quality parameter, adjusting and reducing the setting value of the image quality parameter to the reference value of the image quality parameter if the setting value of the image quality parameter is greater than the reference value of the image quality parameter, and continuously calling the setting value of the image quality parameter if the setting value of the image quality parameter is equal to or less than the reference value of the image quality parameter.

14. The device for adjusting image quality according to claim 13, wherein the processor is further configured to:
acquiring the current playing time of the video content; and determining whether the current playing time falls within the pre-determined time period; performing the image quality adjustment procedure if the current playing time falls within the pre-determined time period; and
continuously calling the setting value of the image quality parameter if the current playing time does not fall within the pre-determined time period.

15. The device for adjusting image quality according to claim 13, wherein the processor is further configured to:
sending a prompt signal; and determining whether a corresponding feedback signal is received within a delay time; executing the image quality adjustment procedure if the corresponding feedback signal is received within the delay time; and continuously calling the setting value of the image quality parameter if the corresponding feedback signal is not received within the delay time.

16. The device for adjusting image quality according to claim 15, wherein the processor is further configured to:
receiving the prompt signal through a display unit; and controlling lamp flicking according to the prompt signal or displaying a prompt frame.

17. The device for adjusting image quality according to claim 15, wherein the processor is further configured to:
receiving the prompt signal through a remote controller; and
generating vibrations by the remote controller according to the prompt signal.

18. The device for adjusting image quality according to claim 13, wherein the processor is further configured to:
setting the pre-determined time period; setting the setting value of the image quality parameter corresponding to the brightness value; and setting the reference value of the image quality parameter corresponding to the type of the video content.
